(19) United States
(12) Patent Application Publication
(10) Pub. No.: US 2010/0252079 A1
(43) Pub. Date: Oct. 7, 2010

(54) Sand Infill and Washing Apparatus

(76) Inventor: Wenhong Chen, Tianjin (CN)

Correspondence Address: BRENT A. CAPEHART, 1413 MCCOY DRIVE, SUITE A, HARRISON, AR, 72601, US

(21) Appl. No.: 12/753,441

(22) Filed: Apr. 2, 2010

(30) Foreign Application Priority Data
Apr. 7, 2009 (CN) ZL 2009 2 0096196

(51) Int. Cl. B08B 3/04

(52) U.S. Cl. 134/104.3

(57) ABSTRACT

The present invention is directed toward a sand infilling and washing machine having a sand sample washer, a clean water tank, a wastewater recycling canister, a wastewater recycling pump and a sand infilling spiral conveyor. A filling spout is set between the sand infilling spiral conveyor and a slurry shaker. The sand outlet of the sand infilling spiral conveyor is connected with the sand inlet of the sand sample washer by a conveying duct. The water discharge outlet of the sand sample washer is connected with the wastewater recycling canister by a duct. The wastewater recycling pump is set in the wastewater recycling canister. The discharge outlet of the pump is connected with the filling spout of the sand infilling spiral conveyor by the wastewater duct. The outlet of the clean water tank is connected with the water inlet of the sand sample washer by the duct.

### REFERENCE TO FOREIGN APPLICATIONS

This application is based on Chinese Patent Application ZL 2009 2 00961963 filed Apr. 7, 2009.

### BACKGROUND OF THE INVENTION

1. Technical Field

The present invention is directed to screening equipment used to clean and collect sand sample during the process of well logging.

2. Existing Technologies

The sand sample obtained during the process of well logging is the most important substance for the geologists to make a study in the oil-gas potential and stratigraphic correlation. To separate the sand sample from the slurry, a slurry shaker or a sand sample washer is usually used. By these methods a lot of clean water is needed. The used water cannot be made use of in the recycling way so that a substantial amount of clean water is squandered.

In addition, the sand sample washer should be fed by men with a high labor intensity and low efficiency. Moreover, the solid and heavy helical blade drive shaft of the sand sample washer may easily cause low efficiency and damage to the device.

### BRIEF SUMMARY OF THE INVENTION

The present invention is generally directed toward screening equipment used to clean and collect sand sample during the process of well logging. The present invention discloses a new type of sand infilling and washing machine and aims at providing equipment which can be fed automatically with the cleaning water used in a recycling way so that a large amount of water can be used in an economical way. The filling spout is set between the sand infilling spiral conveyor and the slurry shaker; the sand outlet of the sand infilling spiral conveyor is connected with the sand inlet of the sand sample washer by the conveying duct; the water discharge outlet of the sand sample washer is connected with the wastewater recycling canister by the duct; the wastewater recycling pump is set in the wastewater recycling canister; the discharge outlet of the pump is connected with the filling spout of the sand infilling spiral conveyor by the wastewater duct; the outlet of the clean water tank is connected with the water inlet of the sand sample washer by the duct.

The sand infilling and washing machine is invented to feed the sand washer automatically and recycle the used water in the process of cleaning sand sample so that a substantial amount of water can be used in an economical way.

Upon reading the above description, various alternative embodiments will become obvious to those skilled in the art. These embodiments are to be considered within the scope and spirit of the subject invention, which is only to be limited by the claims which follow and their equivalents.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

### BRIEF DESCRIPTION OF THE DRAWINGS

FIG. 1 is a schematic view of an embodiment of the inventive sand infilling and washing machine.

### DETAILED DESCRIPTION OF THE INVENTION

The attached drawing demonstrates an embodiment of the present invention. It is to be understood that the invention is not limited in its application to the details of the construction and arrangement of parts illustrated in the accompanying drawings. The invention is capable of other embodiments and of being practiced or carried out in a variety of ways. It is to be understood that the phraseology and terminology employed herein are for the purpose of description and not of limitation.

Compared with the prior art, the present invention is designed to feed the sand washer automatically and recycle the used water in the process of cleaning sand sample so that a large amount of water can be used in an economical way.

The characteristics of the present invention are as follows:

The new type of sand infilling and washing machine comprising the sand sample washer, the clean water tank, the wastewater recycling canister, the wastewater recycling pump, the sand infilling spiral conveyor. The filling spout is set between the sand infilling spiral conveyor and the slurry shaker; the sand outlet of the sand infilling spiral conveyor is connected with the sand inlet of the sand sample washer by the conveying duct; the water discharge outlet of the sand sample washer is connected with the wastewater recycling canister by the duct; the wastewater recycling pump is set in the wastewater recycling canister; the discharge outlet of the pump is connected with the filling spout of the sand infilling spiral conveyor by the wastewater duct; the outlet of the clean water tank is connected with the water inlet of the sand sample washer by the duct.

The helical blade drive shaft of the sand sample washer is hollow.

The effects of the present invention are as follows:

1. The sand washer of the present invention of the sand infilling and washing machine can be fed automatically with the labor intensity decreased and the efficiency increased.

2. The sand washer of the present invention of the sand infilling and washing machine can separate the sending water with the cleaning water and recycle the used water in the process of cleaning sand sample so that a large amount of water can be used in an economical way.

3. The hollow helical blade drive shaft of the sand sample washer can avoid the serious friction between the blade and the crust so as to increase the washing efficiency and the duration of service.

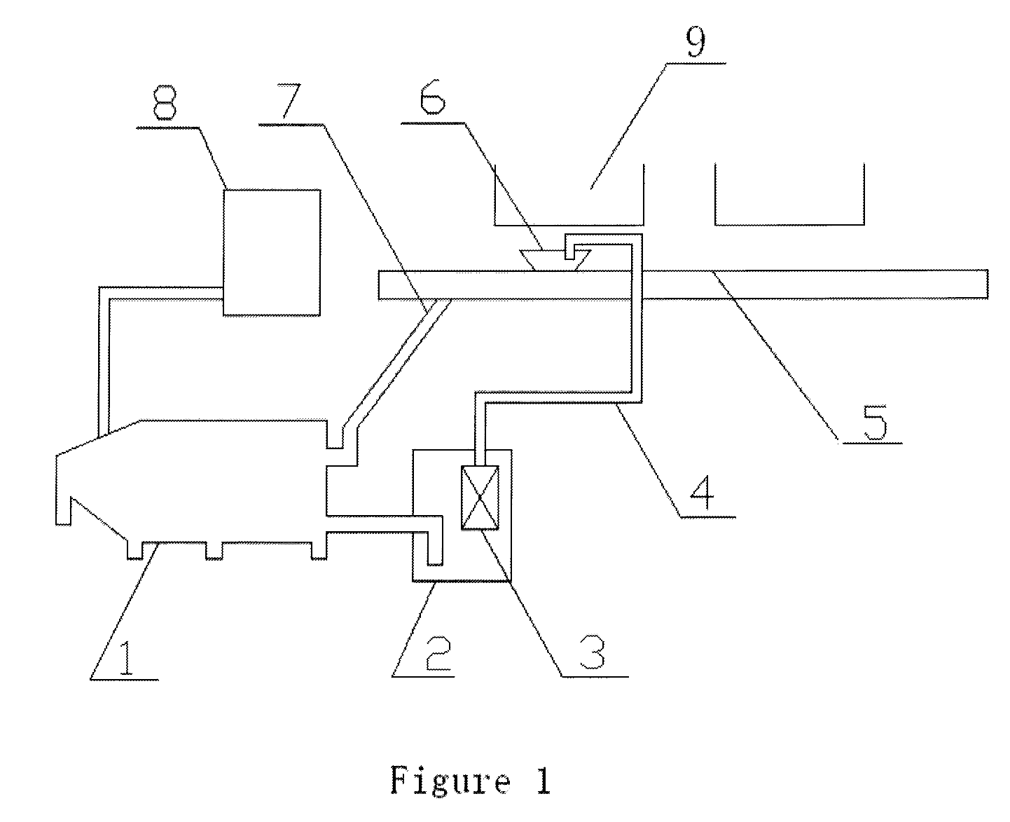

As is shown in FIG. 1, the present invention of the sand infilling and washing machine comprises: the sand sample washer (1), the clean water tank (8), the wastewater recycling canister (2), the wastewater recycling pump (3), the sand infilling spiral conveyor (5), the filling spout (6) is set between the sand infilling spiral conveyor (5) and the slurry shaker (9); the sand outlet of the sand infilling spiral conveyor (5) is connected with the sand inlet of the sand sample washer (1) by the conveying duct (7); the water discharge outlet of the sand sample washer (1) is connected with the wastewater recycling canister (2) by the duct (4); the wastewater recycling pump (3) is set in the wastewater recycling canister (2); the discharge outlet of the pump (3) is connected with the filling spout (6) of the sand infilling spiral conveyor by the wastewater duct (4); the outlet of the clean water tank (8) is connected with the water inlet of the sand sample washer (1) by the duct.

In order to avoid the serious friction between the blade and the crust, the helical blade drive shaft of the sand sample washer is hollow.

In the operation of the equipment, the sand sample washer (1) will be filled with water from the clean water tank (8); the sand infilling spiral conveyor (5) will be fed with the sand sample from the filling spout (6); the sand sample washer (1) will be fed with the sand sample through the conveying duct (7) from the sand infilling spiral conveyor (5); the sand sample washer (1) will clean and filter the sand sample; the cleaning water from the sand sample washer (1) will flow into the wastewater recycling canister (2) through the duct; the filling spout (6) will be filled with the wastewater through the wastewater duct (4) by the wastewater recycling pump (3); the sand sample will flow into the sand infilling spiral conveyor (5) from the slurry shaker (9); the sand sample will be sent into the conveying duct (7) by the sand infilling spiral conveyor (5) and then into the sand inlet of the sand sample washer (1) directly. The cleaning water will flow out of the water discharge outlet of the sand sample washer (1) and will be pumped into the filling spout continuously by the wastewater recycling pump set in the wastewater recycling canister. The sand sample from the slurry shaker will be sent into the sand infilling spiral conveyor by wastewater, and then into the sand sample washer through the conveying duct. The sand sample will be cleaned in the sand infilling spiral conveyor and the sand sample. The process will be repeated again and again. By doing so, the cleaning water can be used in a recycling way without any waste. The structure of the equipment is simple, practical and highly automatic with the water used in a economical way.

The implementation example specifies the sand infilling and washing machine, and yet the specification is not prescriptive but descriptive. Any reasonable modification can be made if not changing the principles of the present invention.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

What is claimed is:

1. A sand infilling and washing machine comprising:
a sand sample washer, said sand sample washer having a sand inlet, a water inlet and a water discharge outlet;
a clean water tank having an outlet, said outlet of the clean water tank connected with said water inlet of the sand sample washer by a first duct;
a wastewater recycling canister, said wastewater recycling canister having a wastewater recycling pump therein, said wastewater recycling pump having a discharge outlet;
a sand infilling spiral conveyor, said sand infilling spiral conveyor having a sand outlet;
a filling spout set between said sand infilling spiral conveyor and a slurry shaker;
said sand outlet of the sand infilling spiral conveyor connected with said sand inlet of said sand sample washer by a conveying duct;
said water discharge outlet of said sand sample washer connected with said wastewater recycling canister by a duct therebetween; and
said discharge outlet of said wastewater recycling pump connected with said filling spout by a wastewater duct.

2. The apparatus of claim 1 wherein said sand sample washer is further defined as having a helical blade drive shaft, said helical blade drive shaft being hollow.
